(19) United States
(12) Patent Application Publication
(10) Pub. No.: US 2016/0115991 A1
(43) Pub. Date: Apr. 28, 2016

(54) CONNECTING ASSEMBLY AND CONNECTING DEVICE

(71) Applicant: HON HAI PRECISION INDUSTRY CO., LTD., New Taipei (TW)

(72) Inventor: FU-KUO HUANG, New Taipei (TW)

(21) Appl. No.: 14/550,387

(22) Filed: Nov. 21, 2014

(30) Foreign Application Priority Data
Oct. 28, 2014 (TW) 103137104

(51) Int. Cl. F16C 11/06

(52) U.S. Cl. CPC F16C 11/0614; F16C 11/0695

(57) ABSTRACT

A connecting assembly includes a first pipe, a second pipe and a connecting part. The connecting part includes a spherical rotating portion. The second pipe includes a connecting portion. The connecting portion includes two clamping parts and defines a sliding groove. The rotating portion is received between the two clamping parts. The connecting part rotates around the spherical rotating portion. The connecting part moves along the sliding groove. The first pipe is rotatably connected to the second pipe.

### CROSS-REFERENCE TO RELATED APPLICATIONS

This application claims priority to Taiwanese Patent Application No. 103137104 filed on Oct. 28, 2014, the contents of which are incorporated by reference herein.

### FIELD

The subject matter herein generally relates to connecting assemblies.

### BACKGROUND

Electronic devices, such as computers, typically include a bracket which can include pipes. To support the computer, the pipes need to be connected together.

### BRIEF DESCRIPTION OF THE DRAWINGS

Implementations of the present technology will now be described, by way of example only, with reference to the attached figures.

FIG. 1 is an exploded, isometric view of one embodiment of a connecting assembly.

FIG. 2 is an assembled view of the connecting assembly of FIG. 1.

FIG. 3 is a cross-sectional view in a connecting assembly taken along line III-III of FIG. 2.

FIG. 4 is a view of the connecting assembly of FIG. 2 in a working state where a first pipe is angled relative to a second pipe.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a connecting assembly.

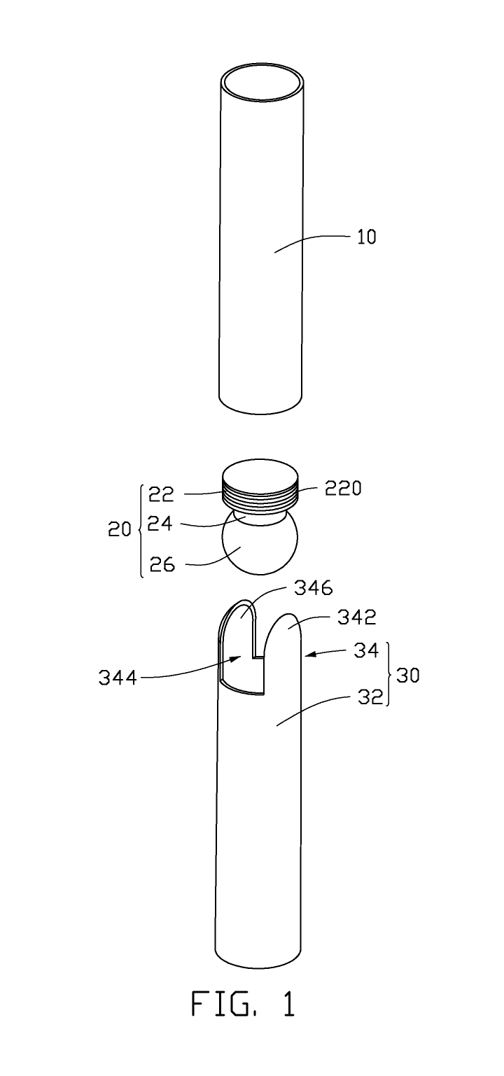

FIG. 1 illustrates one embodiment of a connecting assembly for fixing pipes. The connecting assembly includes a first pipe 10, a connecting part 20, and a second pipe 30.

An end of the first pipe 10 can include an internal thread 12. In at least one embodiment, the first pipe 10 is substantially cylindrical.

The connecting part 20 includes a fixing portion 22, a body 24, and a rotating portion 26. The body 24 extends from the fixing portion 22. The rotating portion 26 extends from the body 24. The body 24 is located between the fixing portion 22 and the rotating portion 26. The fixing portion 22 has an external thread 220. The body 24 is substantially cylindrical. The rotating portion 26 is substantially spherical.

The second pipe 30 includes a pipe body 32 and a connecting portion 34. The connecting portion 34 is located at an end of the pipe body 32. The connecting portion 34 includes two clamping portions 342. The connecting portion 34 defines a sliding groove 344. The sliding groove 344 is located between the two clamping portions 342. A width of the sliding groove 344 is less than a diameter of the spherical rotating portion 26. The width of the sliding groove 344 is greater than or equals to a diameter of the cylindrical body 24. Each clamping portion 342 extends from the pipe body 32. The clamping portions 342 are substantially arc-shaped and flaky. Two clamping portions 342 cooperatively define a receiving space 346.

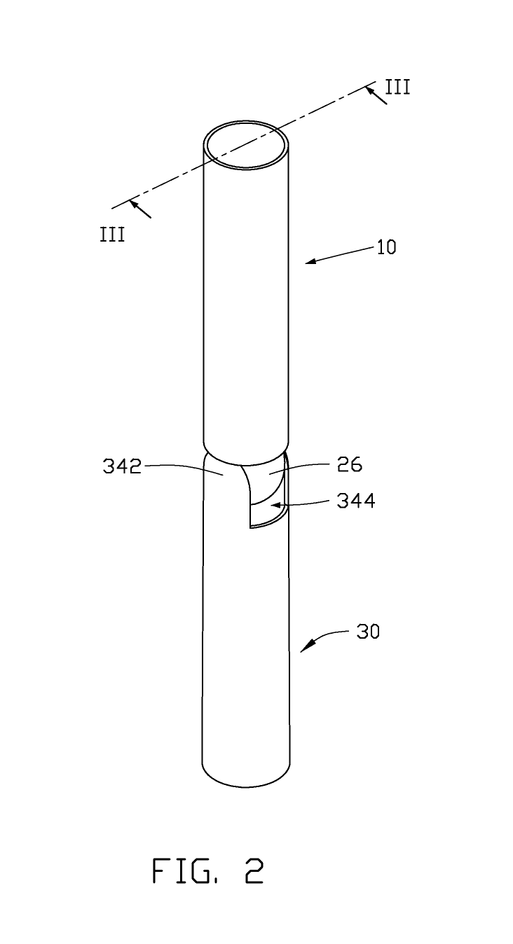

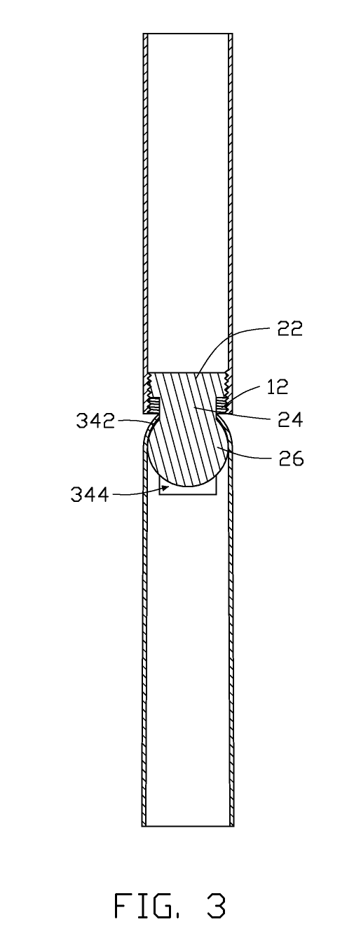

FIGS. 2 and 3 illustrate two views of the assembled connecting assembly. In assembly, the external thread 220 of the fixing portion 22 is fixed with the internal thread 12 of the first pipe 10. The connecting part 20 is fixed with the first pipe 10. The rotating portion 26 is received in the receiving space 346 of the second pipe 30. The clamping portions 342 cover the rotating portion 26.

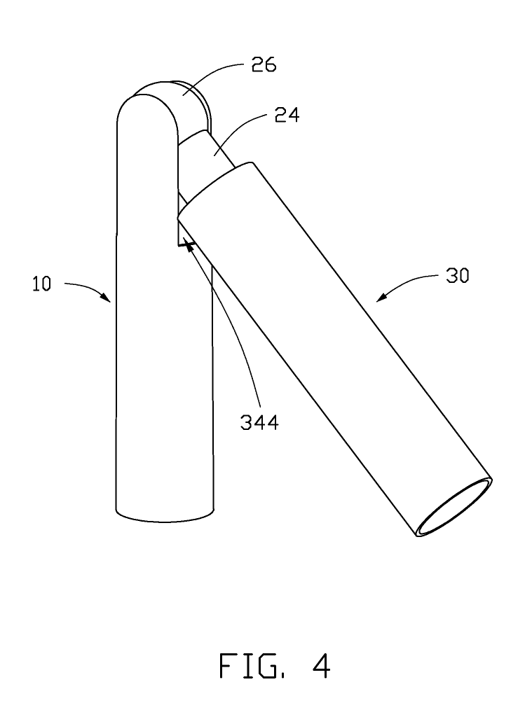

FIG. 4 illustrates when in use, the connecting part 20 rotates around the spherical rotating portion 26. The body 24 of the connecting part 20 moves along the sliding groove 344. The first pipe 10 is rotatably connected to the second pipe 30. In at least one embodiment, the diameter of the first pipe 10 is equal to a diameter of the second pipe 30.

The embodiments shown and described above are only examples. Many details are often found in the art such as the other features of a connecting assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connecting assembly comprising:
a first pipe;
a second pipe comprising a connecting portion, and the connecting portion comprising two clamping portions and defining a sliding groove; and
a connecting part comprising a spherical rotating portion;
wherein the connecting part is fixed with the first pipe, the spherical rotating portion is received between the two clamping portions, the connecting part is configured to rotate around the spherical rotating portion, the connecting part moves along the sliding groove, and the first pipe is rotatably connected to the second pipe.

2. The connecting assembly of claim 1, wherein the sliding groove is located between the two clamping portions.

3. The connecting assembly of claim 1, wherein the second pipe comprises a pipe body, each clamping portion extends from the pipe body, and the clamping portions are substantially arcuate.

4. The connecting assembly of claim 1, wherein an end of the first pipe has an internal thread, the fixing portion has an external thread, and the external thread is fixed with the internal thread.

5. The connecting assembly of claim 1, wherein the connecting part comprises a body, the body is substantially cylindrical, and a width of the sliding groove is greater than or equals to a diameter of the body.

6. The connecting assembly of claim 1, wherein a width of the sliding groove is less than a diameter of the spherical rotating portion.

7. The connecting assembly of claim 1, wherein the diameter of the first pipe equals to a diameter of the second pipe.

8. A connecting assembly comprising:
a second pipe comprising a connecting portion, and the connecting portion comprising two clamping portions and defining a sliding groove; and
a connecting part comprising a spherical rotating portion;
wherein the connecting part is fixed with a first pipe, the spherical rotating portion is received between the two clamping portions, the connecting part is configured to rotate around the spherical rotating portion, the connecting part moves along the sliding groove, and the first pipe is rotatably connected to the second pipe.

9. The connecting assembly of claim 8, wherein the sliding groove is located between the two clamping portions.

10. The connecting assembly of claim 8, wherein the second pipe comprises a pipe body, each clamping portion extends from the pipe body, and the clamping portions are substantially arcuate.

11. The connecting assembly of claim 8, wherein an end of the first pipe can has an internal thread, the fixing portion has an external thread, and the external thread is fixed with the internal thread.

12. The connecting assembly of claim 8, wherein the connecting part comprises a body, the body is substantially cylindrical, and a width of the sliding groove is greater than or equals to a diameter of the body.

13. The connecting assembly of claim 8, wherein a width of the sliding groove is less than a diameter of the spherical rotating portion.

14. A connecting device comprising:
a connecting part comprising a fixing portion, a cylindrical body, and a spherical rotating portion, the cylindrical body extending from the fixing portion, the spherical rotating portion extending from the cylindrical body;
wherein the fixing portion is fixed with a first pipe, and the spherical rotating portion is rotatably connected to a second pipe.
